(19) United States
(12) Patent Application Publication
(10) Pub. No.: US 2011/0104097 A1
(43) Pub. Date: May 5, 2011

(54) TOPICAL COMPOSITIONS FOR THE PRESERVATION OF A HUMAN OR ANIMAL BODY

(76) Inventor: Jean-Luc Dubois, Millery (FR)

(21) Appl. No.: 13/001,667

(22) PCT Filed: Jun. 29, 2009
(86) PCT No.: PCT/FR2009/051253

§ 371 Date: Dec. 28, 2010

(30) Foreign Application Priority Data
Jul. 1, 2008 (FR) 08.54447

(51) Int. Cl. A01N 1/00; A01P 1/00

(52) U.S. Cl. 424/75

(57) ABSTRACT

The present invention relates to a novel composition, having a non-therapeutic purpose, that contains at least one POM (PolyOxyMethylene dialkyl ether) and/or at least on dialdehyde acetal, and also at least one biocidal agent and optionally at least one pro-penetrating agent. It also relates to the topical use of this composition for preserving and/or embalming a human or animal body.

The present invention relates to the field of the preservation of human or animal cadavers. More particularly, the invention relates to a novel composition, having a nontherapeutic aim, including: (a) at least one POM (PolyOxyMethylene dialkyl ether) and/or at least one dialdehyde acetal, (b) at least one biocidal agent and (c) optionally at least one propenetrating agent. It also relates to the topical use of this composition for preserving and/or embalming a human or animal body.

Embalming of the dead body is a practice asked for by the families of the deceased in order for the body to retain an acceptable appearance until it is buried or cremated. However, under some circumstances, this act may become obligatory, in particular in the cases of movements of bodies across frontiers, of transportation of bodies before cremation in caskets with thinner walls than those intended to be interred, indeed even in the absence of a casket, in some cases of returning to their homes the bodies of people who have died in hospital, and also in some cases of deposition in a temporary grave.

In addition, the hygienic preservation of bodies is the modern and efficient means of avoiding the propagation of diseases by contact between the living and dead, and also the pollution and the contamination of objects and the habitat.

Different compounds are known which are used to embalm and/or preserve human or animal cadavers. In particular, phenol and aldehydes, such as formaldehyde and glutaraldehyde (1,5-pentanedial), are commonly used in this field.

However, these compounds, when used at a high dose, are malodorous and toxic and they have a tendency to leave treated bodies in a rigid state.

In addition, the usual methods for the preservation of bodies require the intraarterial injection of embalming compositions after removing the blood present in the deceased. In point of fact, this stage of extraction of the blood, generally carried out after incision of the carotid artery or the femoral artery, is regarded by some religions as an unacceptable mutilation of the deceased.

The need thus remains to have available compositions which are nontoxic to the embalmer and which make it possible to efficiently and rapidly preserve bodies without damaging their integrity.

In point of fact, satisfying this need is complicated by the fact that the majority of the bacteria responsible for the decomposition of the body and which have to be destroyed or which have an activity which has to be inhibited occur in the blood, which it is not desired to remove. These compositions must thus exhibit a sufficient biocidal effect to prevent these bacteria from decomposing the body. Furthermore, the composition must penetrate sufficiently into the body to reach these bacteria.

Furthermore, the need remains to have available compositions having the least possible affect on the esthetic appearance of the body, in particular not increasing, or only increasing to a small degree, the rigidity, the pallor, the emanations of odors and/or the dehydration of the body.

In point of fact, the Applicant Company has now discovered that these needs could be met by applying, topically to the skin of the cadavers, a composition including in particular at least one compound of PolyOxyMethylene dialkyl ether (POM) type and/or at least one dialdehyde acetal.

POM compounds are known but for different uses. For example, French patent FR 2 881 750 describes the use of POMs as fuels for fuel cells.

Likewise, dialdehyde acetals are known in applications other than the embalming of bodies, for example as synthons in organic synthesis (WO 02/42524), additives (EP 0 855 436) or adhesives (FR 2 844 802).

The invention is more particularly targeted at a composition including:
(a) at least one polyoxymethylene dialkyl ether (POM) of formula (I):

R—(OCH₂)ₙ—OR′ (I)
wherein R and R′, identical or different, represent a linear or branched alkyl radical comprising 1 to 5 carbon atoms and n is an index with a value comprised between 1 and 8,
and/or of at least one dialdehyde acetal of formula (II):

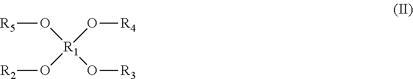

where R₂, R₃, R₄ and R₅ designate independently a linear or branched alkyl radical comprising 1 to 8 carbon atoms, or R₂ and R₅ and/or R₃ and R₄ form together and with the two oxygen atoms to which they are attached a saturated or unsaturated heterocycle with 5 or 6 members optionally substituted by one or more groups chosen from OH, CH₂OH or a linear or branched alkyl radical comprising 1 to 8 carbon atoms; and R₁ represents a CH—R₆—CH group where R₆ forms a bond or represents a linear or branched alkylene radical, comprising 1 to 5 carbon atoms or a saturated or unsaturated carbocycle comprising 3 to 8 carbon atoms; or R₁ is a saturated or unsaturated carbocycle comprising 3 to 8 carbon atoms,
(b) at least one biocidal agent chosen from: formaldehyde, sulfur dioxide, sodium hydrogensulfite, sodium disulfite, sodium sulfite, potassium sulfite, potassium disulfite, bronopol, 1,2-benzisothiazol-3(2H)-one, dodecylguanidine monohydrochloride, glutaral, methylene dithiocyanate, the polymer of N,N□-1,6-hexanediylbis[N′-cyanoguanidine] and of hexamethylenediamine/polyhexamethylene biguanide monohydrochloride, 2-butanone peroxide, m-phenoxybenzyl 3-(2,2-dichlorovinyl)-2,2-dimethylcyclopropane-carboxylate/permethrin, quaternary ammonium chlorides, bis(trichloromethyl) sulfone, boric acid, N,N-diethyl-m-toluamide, 2-methyl-2H-isothiazol-3-one and their mixtures, and
(c) optionally at least one propenetrating agent.

It is understood that, in the context of this description, the term “comprised between” should be interpreted as including the limits indicated.

Within the meaning of the invention, “to preserve” is understood to mean the fact that the enzymatic action is halted or slowed down in human or animal tissue, in comparison with untreated tissue, which prevents or slows down the autocatalytic decomposition of this tissue, and/or that the tissues exhibit better resistance to external attacks of bacteria and mycetae than untreated tissues.

The compounds (I) used according to the invention are PolyOxyMethylene dialkyl ethers which are designated by the symbol POM, for PolyOxyMethylene, to which are added one or two letters (POMXX) making it possible to identify the alkyl radicals R and R′, M for methyl, E for ethyl, P or i-P for (iso)propyl, B for butyl, Pe for pentyl and H for hexyl, and by an index corresponding to the number n of (CH₂O) units (POMXXₙ).

These products are denoted, for example:
POMMₙ (polyoxymethylene dimethyl ether) when the alkyl is a methyl group, CH₃— (OCH₂)ₙ—OCH₃,
POMEₙ (polyoxymethylene diethyl ether) when the alkyl is an ethyl group,
POMPₙ (polyoxymethylene dipropyl ether) when the alkyl is a propyl group,
POMBₙ (polyoxymethylene dibutyl ether) when the alkyl is a butyl group.

POMMₙ will be used to describe the compound with n oxymethylene (formaldehyde) units. Thus, methylal (n=1) will be known as POMM₁ and butylal will be known as POMB₁. If a mixture of products resulting from the same synthesis is used, it will be known, for example, as POMM₃₋₈, for a mixture comprising POMMs of n=3 to 8.

These POMs are asymmetric in the case where R is different from R′. It will be possible, for example, to have a POMME₂, which will designate a polyoxymethylene methyl ethyl ether with two (CH₂O) units, i.e. CH₃—(OCH₂)₂—OC₂H₅.

The advantages exhibited by the POMs are probably related to their chemical nature, which itself depends on their method of synthesis, by which it is possible to control the chain length. Generally, the boiling point of POMs increases with the number of formaldehyde (CH₂O) units and with the length of the alkyl chain. On the other hand, the solubility in water decreases with the (—CH₂O—)ₙ chain length and with the length of the alkyl chains.

From the viewpoint of the toxicity, methylal (POMM₁), ethylal (POME₁) and butylal (POMB₁) are much less toxic than methanol and formaldehyde.

Another advantage of the POMs is their low cost. This is because the synthesis of POMs involves methanol and formaldehyde, itself produced from methanol.

The synthesis of POMs has been well known for many years.

In particular, the book by J. F. Walker, “Formaldehyde”, Robert E. Krieger Publishing Company, Huntington, N.Y., 3rd edition of 1975, is a reference work on the subject. Specifically, there may be found therein the description of the methods of synthesis on pages 167 et seq., on the one hand, and 264 et seq., on the other hand. These synthetic processes are based on an acid catalysis of the reaction of an alcohol (methanol or ethanol) or of an acetal (methylal or ethylal) with formaldehyde or an equivalent compound. This type of synthesis is also illustrated in numerous patent documents, such as U.S. Pat. No. 2,449,469 or JP 47-40772.

Other synthetic methods based on a catalysis of Lewis acid type have also been described. Mention may be made of the patent document GB 1 120 524, which describes the synthesis of stable polyoxymethylene diethers with ionic catalysts of Lewis acid type.

Mixed POMs, that is to say those corresponding to the general formula R—(OCH₂)ₙ—OR′ with R different from R′, are obtained either by direct synthesis according to the processes targeted above or by transacetalization of two different symmetrical (R═R′) POMs.

According to an advantageous embodiment, the invention is targeted at the use of at least one compound chosen from CH₃—(OCH₂)—OCH₃, CH₃—(OCH₂)₂—OCH₃, CH₃—(OCH₂)₃—OCH₃, CH₃—(OCH₂)₄—OCH₃, CH₃—(OCH₂)₅—OCH₃, CH₃—(OCH₂)₆—OCH₃, CH₃—(OCH₂)₇—OCH₃, CH₃—(OCH₂)₈—OCH₃, C₂H₅—(OCH₂)—OC₂H₅, C₂H₅—(OCH₂)₂—OC₂H₅, C₂H₅—(OCH₂)₃—OC₂H₅, C₂H₅—(OCH₂)₄—OC₂H₅, C₂H₅—(OCH₂)₅—OC₂H₅, C₂H₅—(OCH₂)₆—OC₂H₅, C₂H₅—(OCH₂)₇—OC₂H₅, C₂H₅—(OCH₂)₈—OC₂H₅, C₄H₉—(OCH₂)—OC₄H₉, CH₃—(OCH₂)—OC₂H₅, 1,1,2,2-tetraethoxyethane, 1,1,3,3,-tetraethoxypropane, 1,1,3,3-tetramethoxypropane, 1,4,9,12-tetraoxadispiro[4.2.4.2]tetradecane, and mixtures thereof and very preferentially from CH₃— (OCH₂)—OCH₃, CH₃—(OCH₂)₂—OCH₃, C₂H₅—(OCH₂)—OC₂H₅, C₄H₉— (OCH₂)—OC₄H₉, 1,1,2,2,-tetraethoxyethane, 1,1,3,3-tetraethoxypropane, 1,1,3,3-tetramethoxypropane, 1,4,9,12-tetraoxadispiro[4.2.4.2]-tetradecane, and mixtures thereof.

According to an advantageous embodiment, the invention relates to the use of at least one compound of the formula R—(OCH₂)ₙ—OR′ having a symmetrical structure (R═R′).

According to a preferred embodiment, the invention is targeted at the use of a mixture of compounds of formula R—(OCH₂)ₙ—OR in which either R represents a methyl and n ranges from 2 to 8 or R represents an ethyl and n ranges from 1 to 8.

According to an even more preferred embodiment, the invention is targeted at the use of at least one compound POMM₂₋₈ which is a mixture of compounds of formula CH₃—(OCH₂)ₙ—OCH₃ with n comprised between 2 and 8, the composition of which is, for example, as follows:

| n | 2 | 3 | 4 | 5 | 6 | 7 | 8 |
|---|---|---|---|---|---|---|---|
| % | 25-50 | 20-40 | 10-25 | 5-10 | 2-5 | <2 | <1 |

More particularly, a preferred composition of a POMM₂₋₈ compound is as follows:

| n | 2 | 3 | 4 | 5 | 6 | 7 | 8 |
|---|---|---|---|---|---|---|---|
| % | 44 | 32 | 14 | 6 | 2.5 | 1 | <1 |

According to an even more preferred embodiment, the invention is targeted at the use of at least one POME₁₋₈ compound which is a mixture of compounds of formula C₂H₅—(OCH₂)ₙ—OC₂H₅ with n comprised between 1 and 8, the composition of which is, for example, as follows:

| n | 1 | 2 | 3 | 4 | 5 | 6 | 7 | 8 |
|---|---|---|---|---|---|---|---|---|
| % | 58 | 26 | 10 | 4 | 1.5 | <l | <1 | <1 |

Mention may be made, as compounds of formula (II), for example, of glyoxal (ethanedial), propanedial and glutaraldehyde (pentanedial) diacetals, in particular those of formula:

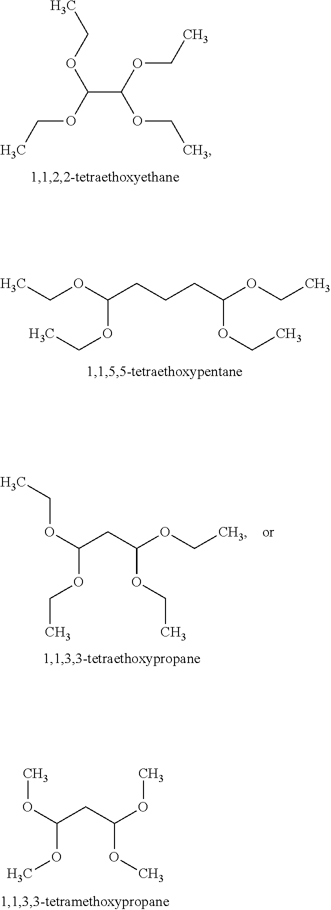

malonaldehyde diacetals, succinaldehyde diacetals, and also dialdehyde cyclic diacetals,

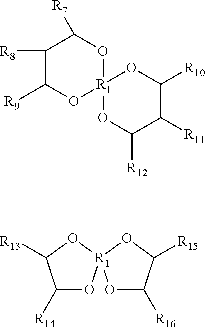

where R₇-R₁₆ represent independently H, OH, CH₂OH or a linear or branched alkyl radical comprising 1 to 8 carbon atoms; and R₁ represents a CH—R₆—CH group where R₆ is defined as above, such as, for example:

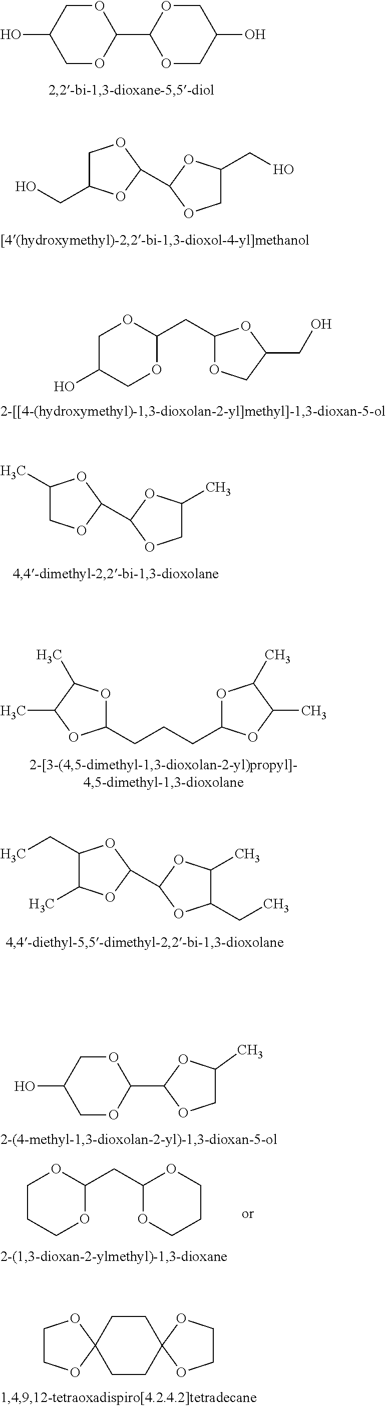

The methods for the synthesis of the compounds (II) according to the invention are well known. For example, French patent application FR 2 844 802 indicates that diacetals can be obtained by reaction of dialdehydes, such as glyoxal, malonaldehyde or glutaraldehyde, with alcohols, such as, for example, monoalcohols, for example methanol or ethanol, dials, for example ethylene glycol, diethylene glycol, 1,4-butanediol or neopentyl glycol, or polyols, for example glycerol or pentaerythritol.

The compound(s) of formula (I) and/or of formula (II) can represent from 5 to 90% by weight, for example from 10 to 50% by weight, with respect to the total weight of the composition according to the invention.

In addition to these compounds, the composition according to the invention includes at least one biocidal agent.

This expression is understood in particular to mean the compounds identified as such in EC Regulation No. 1018/2005 of Jun. 13, 2005 as “Active substances for embalming and taxidermist fluids”, namely: formaldehyde, sulfur dioxide, sodium hydrogensulfite, sodium disulfite, sodium sulfite, potassium sulfite, potassium disulfite, bronopol, 1,2-benzisothiazol-3(2H)-one, dodecylguanidine monohydrochloride, glutaral, methylene dithiocyanate, the polymer of N,N□-1,6-hexanediylbis[N′-cyanoguanidine] and of hexamethylenediamine/polyhexamethylene biguanide monohydrochloride, 2-butanone peroxide, m-phenoxybenzyl 3-(2,2-dichlorovinyl)-2,2-dimethylcyclopropane-carboxylate/permethrin, quaternary ammonium chlorides, bis(trichloromethyl) sulfone, boric acid, N,N-diethyl-m-toluamide, 2-methyl-2H-isothiazol-3-one. Use may also be made, as biocides, of the compounds of formula (C₃H₄O)ₙ.(C₃H₄O₂)ₘ where n>m, such as Chemyde® from Chemeq, and also polyvinylpyrrolidone iodide, available in particular from Graymor Chemical Hamburg and described in patent application EP 1 365 646, and their mixtures.

These biocidal agents are generally present in a low amount in the composition according to the invention.

Thus, they represent, for example, from 2 to 90% by weight, preferably from 4 to 50% by weight, with respect to the total weight of the composition. Before use, the composition can be diluted by the embalmer so that the concentration of biocidal agent is, for example, between 0.2 and 80% by weight.

The composition according to the invention can also include at least one propenetrating agent.

This expression is understood to mean the agents (other than water) which promote the penetration of the composition into the body, through the sudoriferous ducts, via the hair follicles or the sebaceous glands, or else through the stratum corneum and as far as into the dermis. Propenetrating agents of the latter type are preferred for use in the present invention. These agents can increase the permeability of the stratum corneum, for example by dissolving or disrupting the intercellular lipid bilayer structure or by acting with the intracellular proteins or by improving the partition coefficient of the compounds of formula (I) and/or of formula (II) in the stratum corneum. In an alternative form, the propenetrating agents can act as vectors which improve the transportation of the compounds of formula (I) and/or of formula (II) through the stratum corneum.

Propenetrating agents which can be used in the present invention are in particular: linear or branched C₂-C₆ monoalcohols, such as ethanol or n-butanol; polyols, such as propylene glycol, glycerol, dipropylene glycol and polyethylene glycol; C₈-C₂₂ fatty acids, preferably mono- or polyunsaturated fatty acids, such as oleic acid, linoleic acid, lauric acid, caprylic acid or capric acid; cyclodextrins; isosorbide and isosorbide derivatives, such as dimethyl isosorbide (see application US 2008/0003273) and isosorbide dinitrate, surfactants, including sucrose fatty acid esters, such as sucrose oleate, sorbitan fatty acid esters, ethers of fatty alcohols and of polyethylene glycol (PEG), such as PEG oleyl ethers, polyethoxylated hydrogenated castor oils and phospholipids, such as lecithin; esters, such as C₁-C₄ alkyl acetates, glycerol or propylene glycol fatty acid mono- and polyesters, such as glycerol monolaurate or trioleate, lactic acid or glycolic acid fatty alcohol esters and isopropyl fatty acid esters; C₈-C₁₈ fatty alcohols, such as n-nonanol, oleyl alcohol and lauryl alcohol; azones, such as N-alkylazacycloheptan-2-one; alkyl N,N-dialkylamino-alkanoates, such as dodecyl 2-(N,N-dimethylamino)-propionate (DDAIP); amides, such as N,N-diethyl-m-toluamide; urea and urea derivatives, such as allantoin; terpenes and terpenoids, such as essential oils, for example menthol, thymol and camphor; methyl or benzyl nicotinate; sulfoxides, such as DMSO (dimethyl sulfoxide) or decyl methyl sulfoxide; and their mixtures.

Other examples of propenetrating agents are cited by Osborne et al. in the paper “Skin Penetration Enhancers Cited in the Technical Literature”, published in Pharmaceutical Technology (November 1997). Mixtures of monoalcohols or of cyclodextrins with other propenetrating agents are particularly useful. Furthermore, it is preferable for the propenetrating agents according to the invention not to comprise pyrrolidones (such as N-methyl-2-pyrrolidone).

In some cases, in order to improve the penetration of the composition into the skin, the propenetrating agent can be used to encapsulate the compounds of formula (I) and/or of formula (II) in vesicles, such as liposomes, niosomes or nanocapsules, or to form complexes starting from these compounds. It is thus possible in particular to form inclusion complexes of these active compounds with a cyclodextrin.

The propenetrating agents can, for example, represent from 1 to 80% by weight, preferably 5 to 70% by weight, with respect to the total weight of the composition. According to one embodiment of the invention, they can be present in a ratio with the compounds of formula (I) and/or of formula (II) which makes it possible to obtain a eutectic mixture.

The composition according to the invention can additionally comprise at least one coloring agent, such as Orange Yellow S, titanium dioxide and/or zinc oxide; at least one agent which produces an aroma, such as mint, coriander, thyme, citronella and/or grapefruit; at least one humectant; and their mixtures.

This composition can be provided in any formulation form suitable for topical application to the skin, in particular in the solution, emulsion or gel form. They can have a liquid, semiliquid or solid consistency and thus be provided in the lotion, fluid, cream, paste or indeed even foam form. This composition can optionally be packaged in a pump-action spray or an aerosol device.

Another subject matter of the invention is the topical use of the abovementioned composition in the preservation of a human or animal body.

In an advantageous embodiment, the body can be immersed in the composition. In another advantageous embodiment, the composition can be applied to the body by topical route, especially by brushing.

It is also possible according to the invention to improve the transdermal penetration of the composition by use of one or more techniques, such as ionophoresis, electroporation, sonophoresis or phonophoresis, as described in particular by Cross et al. in Curr. Drug Delivery, 2004, 1, 81-92, by Barry et al. in Eur. J. Pharm. Sci., 2001, 14, 101-14, or by Tao et al. in Adv. Drug Delivery Rev., 2003, 55, 315-28.

The invention will now be illustrated by the following nonlimiting example, which does not have the aim of limiting the scope of the invention defined by the appended claims.

### EXAMPLE

The mortal remains of a duck are brushed with a solution comprising 600 ml of POMM₂₋₈ having the following composition:

| n | 2 | 3 | 4 | 5 | 6 | 7 | 8 |
|---|---|---|---|---|---|---|---|
| % | 44 | 32 | 14 | 6 | 2.5 | 1 | <1 |

200 ml of butanol, 150 ml of glutaraldehyde, 100 ml of saline solution, 80 ml of soap and 20 ml of colorant and plant essences.

1. Composition comprising:
(a) at least one polyoxymethylene dialkyl ether (POM) of formula (I):
R—(OCH₂)ₙ—OR′ (I)
wherein R and R′ represent a linear or branched alkyl radical comprising 1 to 5 carbon atoms and n is a value between 1 and 8,
and/or at least one dialdehyde acetal of formula (II): 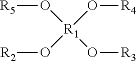
where R₂, R₃, R₄ and R₅ represent a linear or branched alkyl radical comprising 1 to 8 carbon atoms, or R₂ and R₅ and/or R₃ and R₄ form together and with the two oxygen atoms to which they are attached a saturated or unsaturated heterocycle with 5 or 6 members optionally substituted by one or more groups selected from the group consisting of OH, CH₂OH and a linear or branched alkyl radical comprising 1 to 8 carbon atoms; and R₁ represents a CH—R₆—CH group where R₆ forms a bond or represents a linear or branched alkylene radical, comprising 1 to 5 carbon atoms or a saturated or unsaturated carbocycle comprising 3 to 8 carbon atoms; or R/is a saturated or unsaturated carbocycle comprising 3 to 8 carbon atoms,
(b) at least one biocidal agent selected from the group consisting of: formaldehyde; sulfur dioxide, sodium hydrogensulfite, sodium disulfite, sodium sulfite, potassium sulfite, potassium disulfite, bronopol, 1,2-benzisothiazol-3(2H)-one, dodecylguanidine monohydrochloride, glutaral, methylene dithiocyanate, a polymer of N,N-1,6-hexanediylbis[N′-cyanoguanidine] and hexamethylenediamine/polyhexamethylene biguanide monohydrochloride, 2-butanone peroxide, m-phenoxybenzyl 3-(2,2-dichlorovinyl)-2,2-dimethylcyclopropanecarboxylate/permethrin, quaternary ammonium chlorides, bis(trichloromethyl) sulfone, boric acid, N,N-diethyl-m-toluamide, 2-methyl-2H-isothiazol-3-one, compounds of the formula (C₃H₄O)ₙ.(C₃H₄O₂)ₘ where n>m, polyvinylpyrrolidone iodide and their mixtures, and
(c) optionally at least one propenetrating agent.

2. Composition according to claim 1, characterized in that the compound of formula (I) is selected from the group consisting of CH₃—(OCH₂)—OCH₃, CH₃—(OCH₂)₂—OCH₃, CH₃—(OCH₂)₃—OCH₃, CH₃—(OCH₂)₄—OCH₃, CH₃—(OCH₂)₅—OCH₃, CH₃—(OCH₂)₆—OCH₃, CH₃—(OCH₂)₇—OCH₃, CH₃—(OCH₂)₈—OCH₃, C₂H₅—(OCH₂)—OC₂H₅, C₂H₅—(OCH₂)₂—OC₂H₅, C₂H₅—(OCH₂)₃—OC₂H₅, C₂H₅—(OCH₂)₄—OC₂H₅, C₂H₅—(OCH₂)₅—OC₂H₅, C₂H₅—(OCH₂)₆—OC₂H₅, C₂H₅—(OCH₂)₇—OC₂H₅, C₂H₅—(OCH₂)₈—OC₂H₅, C₄H₉—(OCH₂)—OC₄H₉, CH₃—(OCH₂)—OC₂H₅, 1,1,2,2-tetraethoxyethane, 1,1,3,3-tetraethoxypropane, 1,1,3,3-methoxypropane, 1,4,9,12-tetraoxadispiro[4.2.4.2]tetradecane, and mixtures thereof and very preferentially from CH₃—(OCH₂)—OCH₃, CH₃—(OCH₂)₂—OCH₃, C₂H₅—(OCH₂)—OC₂H₅, C₄H₉—(OCH₂)—OC₄H₉, 1,1,2,2-tetraethoxyethane, 1,1,3,3-tetraethoxypropane, 1,1,3,3-tetramethoxypropane, 1,4,9,12-tetraoxadispiro[4.2.4.2]tetradecane, and mixtures thereof.

3. Composition according to claim 1, characterized in that the compound of formula (I) is a POMM₂₋₈ compound comprising a mixture of compounds of formula CH₃—(OCH₂)ₙ—OCH₃ with n comprised between 2 and 8.

4. Composition according to claim 1, characterized in that the compound of formula (I) is a POME₁₋₈ compound comprising a mixture of compounds of formula C₂H₅—(OCH₂)ₙ—OC₂H₅ with n comprised between 1 and 8.

5. Composition according to claim 1, characterized in that the compound of formula (II) is selected from the group consisting of: glyoxal (ethanedial), propanedial and glutaraldehyde (pentanedial) diacetals.

6. Composition according to any one of claim 1, characterized in that the propenetrating agent is selected from the group consisting of: linear or branched C₂-C₆ monoalcohols; polyols; C₈-C₂₂ fatty acids; cyclodextrins; surfactants; C₁-C₄ alkyl acetates, glycerol or propylene glycol fatty acid mono- and polyesters, lactic acid or glycolic acid fatty alcohol esters and isopropyl fatty acid esters; C₈-C₁₈ fatty alcohols; azones; alkyl N,N-dialkylamino-alkanoates; amides; urea and urea derivatives; terpenes and terpenoids; methyl or benzyl nicotinate; sulfoxides; isosorbide and its derivatives; and their mixtures.

7-9. (canceled)

10. A method of preserving a human or animal body comprising applying the composition of claim 1 topically.

11. The method of claim 10 wherein said body is immersed in said composition.

12. The method of claim 10 wherein said composition is applied to said body by brushing.
